(19) United States
(12) Patent Application Publication
(10) Pub. No.: US 2011/0240380 A1
(43) Pub. Date: Oct. 6, 2011

(54) SUNSHINE ANGLE ADJUSTABLE SOLAR ENERGY ELECTRIC WHEEL CHAIR

(76) Inventors: Tianyun Zhao, Beijing (CN); Le jun Su, Beijing (CN); Xiaofeng Zhao, Beijing (CN)

(21) Appl. No.: 12/934,342

(22) PCT Filed: Mar. 25, 2008
(86) PCT No.: PCT/CN2008/070574

§ 371 Date: Sep. 24, 2010

(51) Int. Cl. B60K 16/00; B60L 8/00

(52) U.S. Cl. 180/2.2

(57) ABSTRACT

A sunshine angle adjustable solar energy electric wheel chair, a solar energy cell is mounted on the electric wheel chair so as to charge up a storage battery, left and right horizontal pipes for mounting the cell are supported by four lifted stand pipes, the height of the lifted stand pipes is adjusted, i.e. the sunshine angle may be adjusted at six azimuth, so that the charging current is maximized.

### TECHNICAL FIELD

The present invention relates to a vehicle for the aged and the disabled, and more particularly to a super energy-saving solar powered wheel chair with an adjustable sunshine angle.

### BACKGROUND OF THE INVENTION

Presently, the electric wheel chair has a serious power wasting problem internationally, and one of the resolutions is to use solar energy. Two inventions about applying solar energy to electric wheel chairs have been filed for patents. However, (1) a solar battery is not mature enough, that is, it is heavy, expensive, and has a low efficiency and a low elasticity; and (2) the structure of the electric wheel chair is not mature, that is, it is too power wasting, such that there is no successful products in the market yet. Because the two inventions cannot solve a basic contradiction, that is, the electric energy provided by the solar battery does not match an electric energy required by the electric wheel chair seriously. An area on a right upper part of the electric wheel chair capable of being used to mount the solar battery is maximally 0.8 m², and if the area barely exceeds 0.8 m², the solar battery may hit the people from front or back, or from left or right. According to an efficiency of the current solar battery, the solar battery of 0.8 m² can only provide the electric energy of 80 W. However, the electric energy required by the current international common electric wheel chair is hundreds of watts, and a power of a driving motor is usually 300 W×2 or 320 W×2. Due to the contradiction between supply and demand with such a great disparity, definitely, no successful solar powered wheel chair comes into the market.

However, till the year of 2008, the situation is greatly changed. In one aspect, a new-type thin solar battery is about to come into the market, which has a light weight, an excellent elasticity, and a price as low as that of the thermal power. In another aspect, a high power-saving electric wheel chair is proposed. The sample of the invention is highly power saving, such that although a silicon plate battery is still adopted, the actual effect of supper energy saving is obtained. If a new-type thin solar battery is further adopted, it is possible to create an electric wheel chair being more practical being foldable, more efficient having an adjustable sunshine angle, more energy saving being five times of the energy saving performance of internationally certificated products, and more inexpensive.

### SUMMARY OF THE INVENTION

The present invention is directed to a super energy-saving solar powered wheel chair with an adjustable sunshine angle, to eliminate disadvantages of the current electric wheel chairs.

The present invention provides an electric wheel chair, which includes a wheel chair frame, stand pipes, horizontal support pipes, and main stand pipes. Back wheels, a front steering wheel, and a front universal wheel disposed on a lower part of the wheel chair frame, and a left arm-rest pipe, a right arm-rest pipe, and arm-rests disposed between the stand pipes and the main stand pipes. The front ends of the left and the right arm-rest pipes are bent as elbows, a hand control direction device is installed on the left elbow, and a speed-adjusting turning handle and a hand pull brake handle integrated in a two-in-one manner is mounted on the right elbow. The electric wheel chair is characterized in that the sunshine angle is adjustable and the electric wheel chair is super energy saving.

Two double-vertical plates are respectively fixedly connected to the two main stand pipes, and another two double-vertical plates are respectively fixedly connected to the elbows of the left and the right arm-rest pipes and the stand pipes. Fixing sleeves are respectively connected to the two pairs of double-vertical plates, and 4 lift pipes are inserted into the four sleeves. A connection hole exists between the lift pipe and the sleeve, and the lift pipe and the sleeve are connected through a spring plunger, such that the lift pipes are flexibly lifted and located. During traveling, the sunshine angle may be adjusted respectively according to six directions, to maximize the solar energy charging current to battery. In the six directions, front and back directions are back inclined, non inclined, front inclined, and left and right directions are left inclined, non inclined, and right inclined. Two batteries respectively hung on the left and the right of the wheel chair which are used for backup and are charged during traveling. One battery may be fully charged in 5 hours, and the other battery is charged in 3 hours for storage. Left and right horizontally mounted connection pipes are respectively connected between top ends of the two lift pipes on the left side and between top ends of the two lift pipes on the right side, in which the lift pipe and the horizontally mounted connection pipes are connected through a universal spindle coupling. A new-type thin solar battery plate, not only covers on the left and the right horizontally mounted connection pipes, but also extends nylon zipper elastic straps from both sides. After passing round the left and the right horizontally mounted connection pipes, each pair of the elastic straps are locked through the nylon zipper, such that the new-type thin solar battery is elastically bound and connected. When the wheel chair frame is unfolded, the new-type thin solar battery is tightened from the two sides by the elastic straps; and while the wheel chair frame is folded, the new-type thin solar battery is released, and is folded together. A power supply line connection device is disposed under the new-type thin solar battery, and a power supply line leads to a controller box from the connection device, and is connected to a power connection of a battery box through a charging plug.

In addition, in the present invention, the new-type thin solar battery may be replaced with a low-power silicon plate solar battery, the silicon plate solar battery is integrally mounted on the left and the right horizontally mounted connection pipes, screws are aligned with mount holes of the silicon plate battery for fastening the silicon plate battery, and the sunshine angle may be adjusted according to the six directions by using the four lift pipes, to maximize the charging current. The connection of the power supply line is also the same, in which the power supply line leads to the charging controller through the connection device, and is connected to the power connection of the battery box through the charging plug, except that the silicon plate battery cannot be folded and is mounted in a manner of rigid connection instead of elastic connection.

The present invention is a super energy-saving foldable electric wheel chair with an adjustable sunshine angle and adopting a new-type thin solar battery, and thereby having advantages of being highly power saving, having a low weight, being capable of traveling for a long distance, having a low cost, being foldable, having a small battery, being capable of entering an elevator and entering houses by driving, having a strong grade climbing capability, and having a speed between 7-10 kilometers, such that the wheel chair is quite suitable for being used by the aged and the disabled.

### DESCRIPTION OF THE FIGURES

FIG. 1 is a schematic structural view of a super energy-saving electric wheel chair with an adjustable sunshine angle and adopting a new-type thin solar battery;

FIG. 2 is a schematic constitutional view of a hand control direction device;

FIG. 3 is a schematic view of mount positions of a back wheel direct driving motor and a disk brake;

FIG. 4 is a schematic view of a cross folding device and a hung-up battery box of a foldable electric wheel chair with an adjustable sunshine angle and adopting a new-type thin solar battery.

FIG. 5 is a back view of a cross folding device of a foldable electric wheel chair with an adjustable sunshine angle;

FIG. 6 is another schematic structural view of a super energy-saving electric wheel chair with an adjustable sunshine angle and adopting a new-type thin solar battery in which an intellectual control rod 40 is installed on a right elbow 12 to replace switches 18 and a switch box 181;

FIG. 7 is a schematic view in which a lift pipe and a horizontally mounted connection pipe are connected through a universal spindle coupling;

FIG. 8 is a schematic view in which a structure adopting a new-type thin solar battery and with an adjustable sunshine angle is back inclined;

FIG. 9 is a schematic view in which a structure adopting a new-type thin solar battery and with an adjustable sunshine angle is not inclined in a front and back direction;

FIG. 10 is a schematic view in which a structure adopting a new-type thin solar battery and with an adjustable sunshine angle is front inclined;

FIG. 11 is a schematic view in which a structure adopting a new-type thin solar battery and with an adjustable sunshine angle is left inclined;

FIG. 12 is a schematic view in which a structure adopting a new-type thin solar battery and with an adjustable sunshine angle is not inclined in a left and right direction;

FIG. 13 is a schematic view in which a structure adopting a new-type thin solar battery and with an adjustable sunshine angle is right inclined; and

FIG. 14 is a schematic structural view of a super energy-saving electric wheel chair with an adjustable sunshine angle and adopting a silicon plate solar battery being not inclined in the front and back direction and the left and right direction.

### DESCRIPTION OF EMBODIMENTS

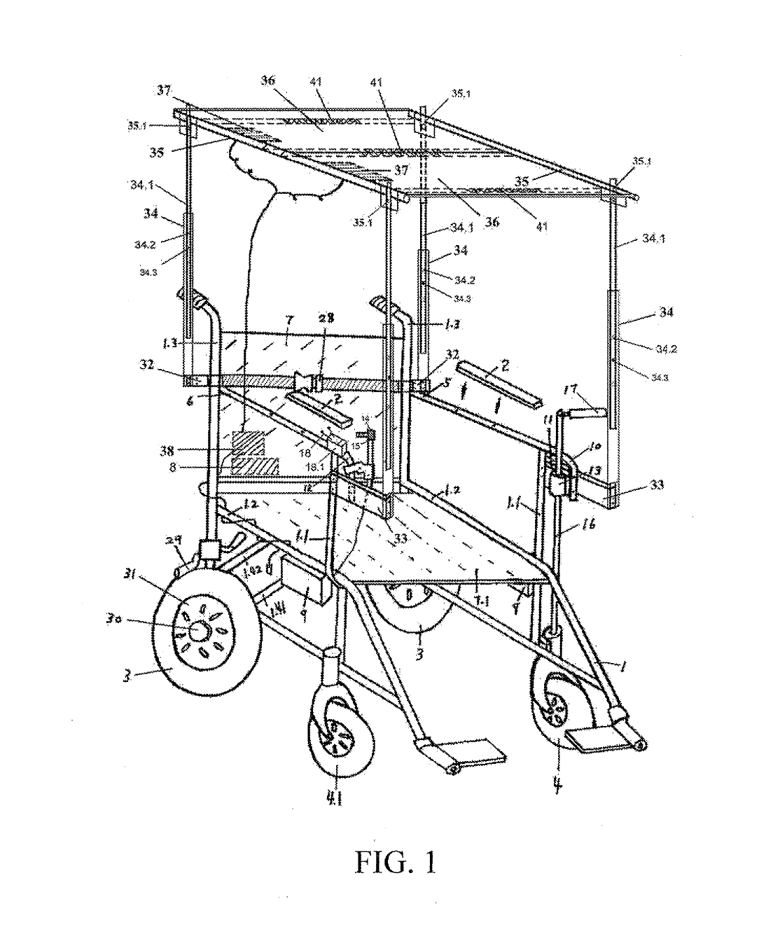

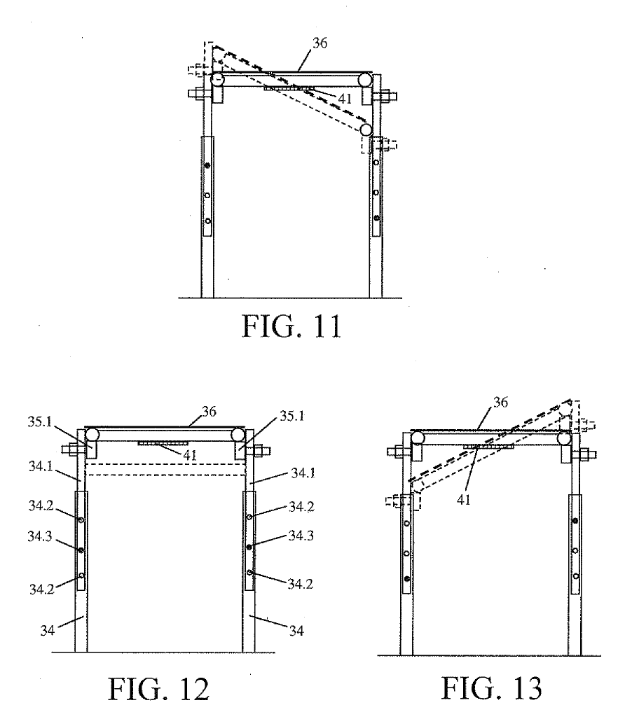

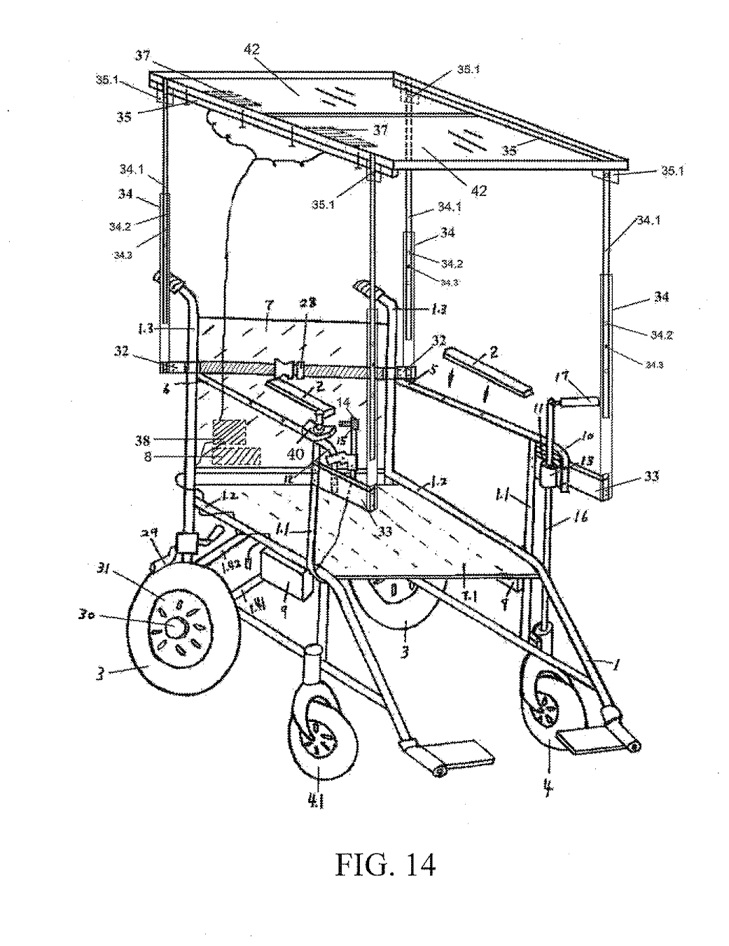

The present invention provides a super energy-saving solar powered wheel chair with an adjustable sunshine angle, and a solar battery used by the wheel chair includes two types: 1. a new-type thin solar battery foldable; and 2. a low-power silicon plate solar battery not foldable. The electric wheel chair includes a wheel chair frame 1 as shown in FIG. 1, stand pipes 1.1, horizontal support pipes 1.2, main stand pipes 1.3, back wheels 3, a front steering wheel 4, a front universal wheel 4.1, a left arm-rest pipe 5, a right arm-rest pipe 6, and arm-rest 2. Front ends of the left and the right arm-rest pipe 5 and 6 are bent to form elbows, and a speed-adjusting turning handle 14 and a brake handle 15 integrated in a two-in-one manner are installed on a right elbow 12. The electric wheel chair is characterized in that a sunshine angle is adjustable, and the electric wheel chair is super energy saving. By adopting a new-type thin solar battery having a low weight having advantages of excellent elasticity and low cost, the electric wheel chair will be more efficient having an adjustable sunshine angle, more practical being foldable, and more energy saving. Double-vertical plates 32 are respectively fixedly connected to the two main stand pipes 1.3, and double-vertical plates 33 are respectively fixedly connected to the elbows of the left and the right arm-rest pipes 5 and 6 and the stand pipes 1.1. Fixing sleeves 34 are respectively connected to the double-vertical plates 32 and 33, and 4 lift pipes 34.1 are inserted into the four sleeves 34. A connection hole 34.2 exists between the lift pipe 34.1 and the sleeve 34, and the lift pipe 34.1 and the sleeve 34 are connected through a spring plunger 34.3, such that the lift pipes 34.1 are flexibly lifted and located, and the sunshine angle may be adjusted respectively according to six directions, to maximize a charging current. In the six directions, front and back directions are back inclined, non inclined, front inclined referring to FIGS. 8, 9, and 10, and left and right directions are left inclined, non inclined, and right inclined referring to FIGS. 11, 12, and 13.

In four seasons of each year and in the morning, at noon, and in the afternoon of each day, the position of the sun changes, such that the adjustment of the sunshine angle in response to the change is quite meaningful for improving a charging efficiency. Daily charging test verifies that as soon as the sunshine angle is adjusted, a charging current displayed on an ampere meter is immediately increased by 10%-20%, and an efficiency of a modern solar battery is merely 15%. The continuous adjustment of the sunshine angle in response to the changes of the position of the sun is just the most important advantage of the present invention, because only the electric wheel chair has more strong points than other vehicles: its speed is low, the changes of the traveling direction is less, the environment is clear, and the manual adjustment may be performed at any moment. The charging efficiency is approximately 30% higher than that of a household water heater being fixed at an angle of 45 degrees. Particularly, at noon of summer and autumn, the stronger the sunshine is, the more difficult for the solar battery fixed at the angle of 45 degrees to entirely receive the vertical incident solar rays. On the contrary, if the adjustable sunshine angle is adopted, the solar battery may basically entirely receive the vertical incident solar rays when lying without fixed angle of 45 degree.

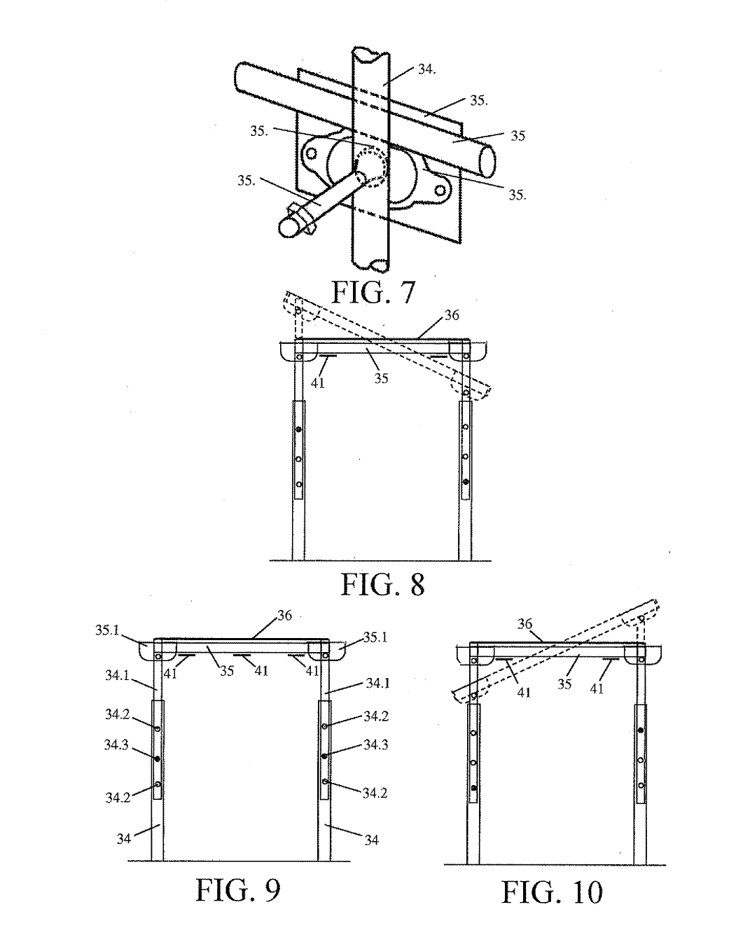

Left and right horizontally mounted connection pipes 35 are respectively connected between top ends of the two lift pipes 34.1 on the left side and between top ends of the two lift pipes 34.1 on the right side, in which the lift pipe 34.1 and the horizontal mount connection pipe 35 are connected through a universal spindle coupling 35.1, and the connection manner is as shown in FIG. 7. A supporting plate 35.2 of the universal spindle coupling 35.1 is welded with the horizontal pipe 35, and a screw 35.4 extended from a universal ball 35.3 of the spindle coupling penetrates through the lift pipe 34.1, and is fasten by a screw nut. A new-type thin solar battery 36 covers on the left and the right horizontally mounted connection pipes 35, and the left and right sides of the new-type thin solar battery not only covers on the left and the right horizontally mounted connection pipes 35, but also extends nylon zipper elastic straps 41 from both sides. After passing round the left and the right horizontally mounted connection pipes 35, each pair of the elastic straps 41 are locked through the nylon zipper, such that the new-type thin solar battery 36 is elastically bound and connected. When the wheel chair frame is unfolded, the new-type thin solar battery 36 is tightened from the two sides by the elastic straps 41; and while the wheel chair frame is folded, the new-type thin solar battery is released, and is folded together. A power supply line connection device 37 is disposed under the new-type thin solar battery 36, and a power supply line leads to a controller box 38 from the connection device 37, and is connected to a power connection of a battery box 9 through a charging plug.

The new-type power-saving thin solar battery shall be accompanied by power-saving driving device and braking device, as shown in FIG. 3.

For the driving device, a speed adjusting turning handle 14 is installed on the right elbow 12, there are two mounting vertical boards 19 of the rear wheels at the lower end of the left and right main vertical pipes 1.3 respectively, the rear wheels 3 with motors 30 are secured on the vertical boards 19 by bolts and nuts, the said motors 30 are DC and brushless motors with stepless adjustable speed, low rotation speed, and high torque, the housing of the motors 30 are integrated with the steel wheel plates 31, so as the two motors 30 can directly drive the two real wheels 3;

For the braking device, two disc brakes 20 are installed on the left and right rear wheels, the disc brake includes a disc brake sheet 21, a brake clamp 22 and a brake rod 23, the disc brake sheet 21 is installed by the side of the motor 30 by means of tightly screwing the female screw of the disc brake sheet 21 in the male screw on the end-cover of the motor 30, the brake clamp 22 and the brake rod 23 are fixed on the vertical board 19 via the connecting plate 27 with screws; a hand pull brake handle 15 is installed on the right elbow 12; the two disc brakes 20 are connected to the brake handle 15 through a delta-shaped conversion plate 26 via a braking steel wire, the upper end of the delta-shaped conversion plate 26 is connected to the brake handle 15 via the main steel wire 24, the left and right lower ends of the delta-shaped conversion plate 26 are connected to the left and right brake rods 23 via the left and right branch steel wires 25 respectively, by means of a single hand to pull brake handle 15 or by means of a small electric device to pull the main steel wire 24, the brake rods 23 are tightly pulled so that the two brake clamps 22 tightly clip the two brake sheets 21, and the two rear wheels 3 are braked simultaneously;

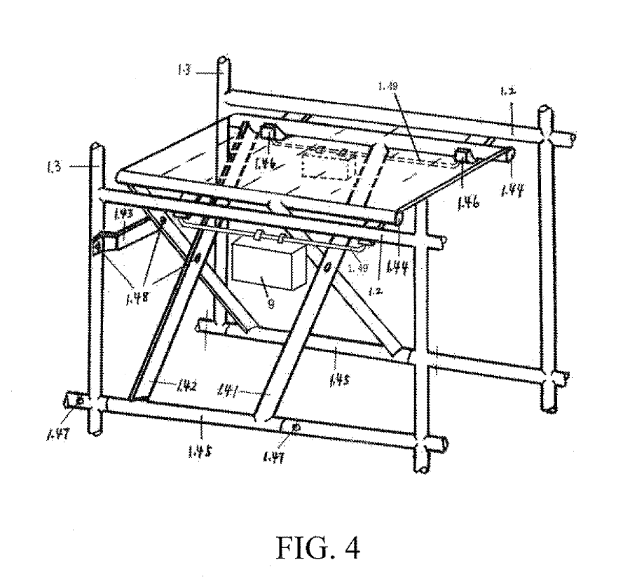

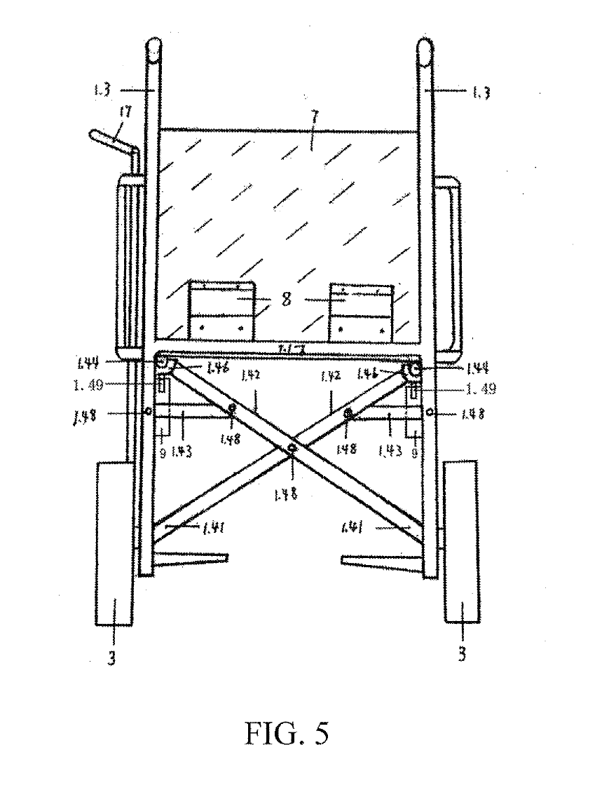

The foldable new-type thin solar battery charging device needs to match with the foldable electric wheel chair frame. As shown in FIGS. 4 and 5, a cross folding device is disposed in the wheel chair frame 1, its base is two front cross pipes 1.41 and two rear cross boards 1.42, the upper end of the two front cross pipes 1.41 and two rear cross boards 1.42 are connected by welding to the left and right horizontally supporting pipes 1.44 of the cushion 7.1, the lower ends of the two front cross pipes 1.41 and two rear cross boards 1.42 are connected by welding to the left and right short pipes 1.45, which may rotate around its inner pipe at a small angle; two cross fold positioning boards 1.43 make the fold and interaction between the two rear cross boards 1.42 and the left and right main vertical pipes 1.3 keep stable by means of four slip-connecting screws 1.48, the cross points of the two front cross pipes 1.41 and the two rear cross boards 1.42 are also connected to each other via the slip-connecting screws 1.48, there is an inner pipe fixing screw 1.47 out of the two ends of the left and right short pipes 1.45 respectively, the screws tightly fix the inner pipes and non-turning outer pipes, there are totally four hook-shaped supporters 1.46 which are welded at the front and rear of the left and right horizontally supporting pipes 1.2 and at the bottom planes tightly close to the supporting pipes 1.2, and used to support the left and right horizontally supporting pipes 1.44 of the cushion 7.1, two long flat vertical plates 1.49 are welded beneath each of the two left hook-shaped supporters and the two right hook-shaped supporters 1.46 respectively for hanging and unhanging the left and right battery boxes 9 conveniently, therefore the electric wheel chair is foldable even with batteries.

As shown in FIG. 1, a safety belt 28 is mounted on a back cushion 7 of the wheel chair. A manual push brake 29 is mounted on left and right on the lower part of the main stand pipe 1.3 of the wheel chair. A controller box 8 and a solar energy charging controller 38 are installed on a back surface of the back cushion 7 of the wheel chair, and are fixed by using screw bolts.

As shown in FIG. 1, a switching case 18.1 is installed on the right arm-rest pipe 6, two switches 18 for positive or inversion running of the motors and the power display are installed on the switching case 18.1

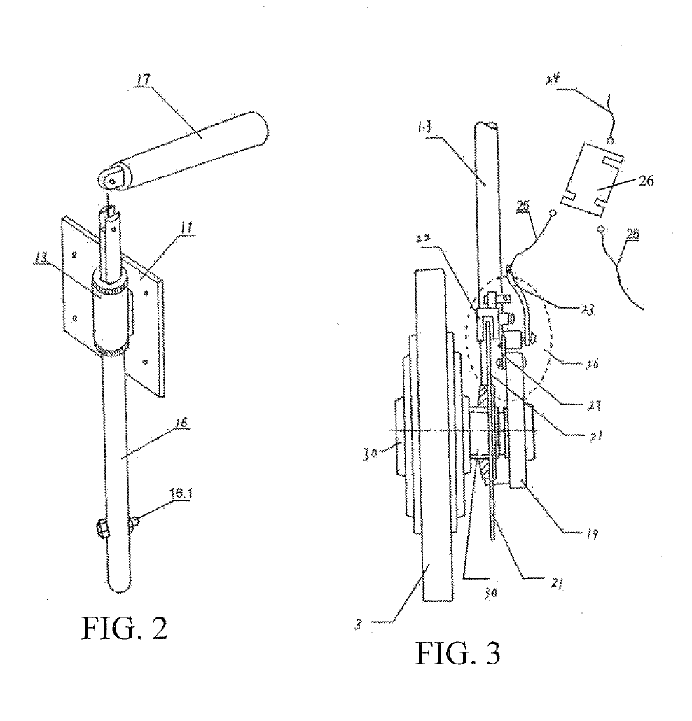

As shown in FIG. 2, a hand control direction device is mounted on the left elbow 10. The hand control direction device includes a fixing plate 11, a hollow bearing 13, a vertical hand control rod 16, and a hand control direction handle 17. The vertical hand control rod 16 inserting through the hollow bearing 13, its upper end is connected to the hand control direction handle 17, and its lower end is connected to the front steering wheel 4. For connection between the vertical hand control rod 16 and the front steering wheel 4, an inner screw thread on a tail end of the vertical hand control rod 16 matches a screw rod on an upper end of a main shaft of the front steering wheel 4, the screw rod is screwed into a top end of the inner screw thread, and is screwed into a positioning screw through a hole.

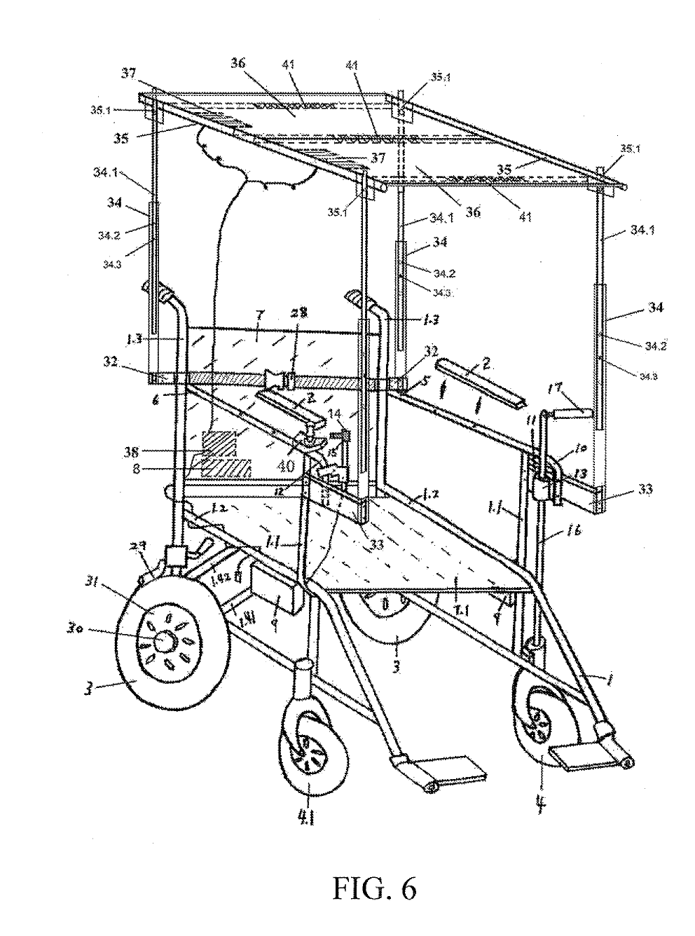

In addition, an intellectual control rod 40 is installed on the right elbow 12 referring to FIG. 6, to replace the left and the right motor reverse switches 18 and the switch box 18.1, and interacts with the hand control direction handle 17. The intellectual control rod is particularly used for coarse adjustment, that is, adjustment of the magnitude of the current, and the general traveling direction of the electric wheel chair, for example, forwarding or reversing, left- or right-hand rotation in place. The hand control direction handle 17 is particularly used for fine adjustment, that is, the accurate adjustment on the particular direction of the left and the right traveling direction of the electric wheel chair. The intellectual control rod 40 must interact with the speed adjusting turning handle 14 and the brake handle 15 both integrated in a two-in-one manner. When a user intends to brake, the right hand quickly leaves the intellectual control rod 40 and moves to the brake handle 15, the thumb pushes the speed adjusting turning handle 14 to enable the wheel chair to keep forwarding, and the other four fingers tightly hold the brake handle 15 and get ready for braking at any moment, so as to shorten the time and the distance for transiting to the brake, and thereby ensuring traveling safety.

What we claim is:

1. A sunshine angle adjustable solar energy electric wheel chair, comprising a wheel chair frame (1), stand pipes (1.1), horizontal support pipes (1.2), main stand pipes (1.3); back wheels (3), a front steering wheel (4), and a front universal wheel (4.1) disposed on a lower part of the wheel chair frame (1), and a left arm-rest pipe (5), a right arm-rest pipe (6), and arm-rests (2) disposed between the stand pipes (1.1) and the main stand pipes (1.3); the front ends of the left and the right arm-rest pipes (5,6) are bent as elbows (10,12), a hand control direction device is installed on the left elbow (10), and a speed-adjusting turning handle (14) and a hand pull brake handle (15) integrated in a two-in-one manner is installed on the right elbow (12); characterized in that sunshine angle of the solar energy electric wheel chair is adjustable and the electric wheel chair is super energy saving, two double-vertical plates (32) are respectively fixedly connected to the two main stand pipes (1.3), and another two double-vertical plates (33) are respectively fixedly connected to the elbows of the left and the right arm-rest pipes (5,6) and the stand pipes (1.1), fixing sleeves (34) are respectively connected to the two pairs of double-vertical plates (32,33), and 4 lift pipes (34.1) are inserted into the four sleeves (34); connection holes (34.2) exist between the lift pipes (34.1) and the sleeves (34), and the lift pipes (34.1) and the sleeves (34) are connected through spring plungers (34.3), such that the lift pipes (34.1) could be flexibly lifted and located; sunshine angle of the electric wheel chair may be adjusted respectively according to six directions to maximize the solar energy charging current to battery during traveling; in the six directions, front and back directions are back inclined, non inclined, front inclined, and left and right directions are left inclined, non inclined, and right inclined; two batteries respectively hung on the left and the right of the wheel chair, which are used for backup and could be charged during traveling; one battery could be fully charged in 5 hours, and the other battery is charged for 3 hours to store energy; left and right horizontally mounted connection pipes (35) are respectively connected between top ends of the two lift pipes (34.1) on the left side and between top ends of the two lift pipes (34.1) on the right side wherein the lift pipes (34.1) and the horizontally mounted connection pipes (35) are connected through universal spindle couplings (35.1); a new-type thin solar battery (36) covers on the left and the right horizontally mounted connection pipes (35), and the left and right sides of the new-type thin solar battery plate not only covers on the left and the right horizontally mounted connection pipes (35), but also extends out nylon zipper elastic straps (41) from both sides; after passing around the left and the right horizontally mounted connection pipes (35), each pair of the elastic straps (41) are locked through the nylon zipper, such that the new-type thin solar battery (36) is elastically bound and connected; when the wheel chair frame is unfolded, the new-type thin solar battery (36) is tightened from the two sides by the elastic straps (41); and while the wheel chair frame is folded, the new-type thin solar battery is released, and is folded together; a power supply line connection device (37) is disposed under the new-type thin solar battery (36), and the power supply line leads to a controller box (38) from its connection device (37), and is connected to a power connection of a battery box (9) through a charging plug.

2. The sunshine angle adjustable solar energy electric wheel chair of claim 1, characterized in that the new-type power-saving thin solar battery shall be accompanied by power-saving driving device and braking device, wherein
said driving device comprising: a speed adjusting turning handle (14) is installed on the right elbow (12), there are two mounting vertical boards (19) of the rear wheels at the lower end of the left and right main vertical pipes (1.3) respectively, the rear wheels (3) with motors (30) are secured on the vertical boards (19) by bolts and nuts, the said motors (30) are DC and brushless motors with stepless adjustable speed, low rotation speed, and high torque, the housing of the motors (30) are integrated with the steel wheel plates (31), so as the two motors (30) can directly drive the two real wheels (3);
said braking device comprising: two disc brakes (20)are installed on the left and right rear wheels, the disc brake includes a disc brake sheet (21), a brake clamp (22) and a brake rod (23), the disc brake sheet (21) is installed by the side of the motor (30) by means of tightly screwing the female screw of the disc brake sheet (21) in the male screw on the end-cover of the motor (30), the brake clamp (22) and the brake rod (23) are fixed on the vertical board (19) via the connecting plate (27) with screws; a hand pull brake handle (15) is installed on the right elbow (12); the two disc brakes (20) are connected to the brake handle (15) through a delta-shaped conversion plate (26) via a braking steel wire, the upper end of the delta-shaped conversion plate (26) is connected to the brake handle (15) via the main steel wire (24), the left and right lower ends of the delta-shaped conversion plate (26) are connected to the left and right brake rods (23) via the left and right branch steel wires (25) respectively, by means of a single hand to pull brake handle (15) or by means of a small electric device to pull the main steel wire (24), the brake rods (23) are tightly pulled so that the two brake clamps (22) tightly clip the two brake sheets (21), and the two rear wheels (3) are braked simultaneously;

3. The sunshine angle adjustable solar energy electric wheel chair of claim 1, characterized in that the foldable new-type thin solar battery charging device must match with the foldable electric wheel chair frame: a cross folding device is disposed in the wheel chair frame (1), its base is two front cross pipes (1.41) and two rear cross boards (1.42), the upper end of the two front cross pipes (1.41) and two rear cross boards (1.42) are connected by welding to the left and right horizontally supporting pipes (1.44) of the cushion (7.1), the lower ends of the two front cross pipes (1.41) and two rear cross boards (1.42) are connected by welding to the left and right short pipes (1.45), which may rotate around its inner pipe at a small angle; two cross fold positioning boards (1.43) make the fold and interaction between the two rear cross boards (1.42) and the left and right main vertical pipes (1.3) keep stable by means of four slip-connecting screws (1.48), the cross points of the two front cross pipes (1.41) and the two rear cross boards (1.42) are also connected to each other via the slip-connecting screws (1.48), there is an inner pipe fixing screw (1.47) out of the two ends of the left and right short pipes (1.45) respectively, the screws tightly fix the inner pipes and non-turning outer pipes, there are totally four hook-shaped supporters (1.46) which are welded at the front and rear of the left and right horizontally supporting pipes (1.2) and at the bottom planes tightly close to the supporting pipes (1.2), and used to support the left and right horizontally supporting pipes (1.44) of the cushion (7.1), two long flat vertical plates (1.49) are welded beneath each of the two left hook-shaped supporters and the two right hook-shaped supporters (1.46) respectively for hanging and unhinging the left and right battery boxes (9) conveniently, therefore the electric wheel chair is foldable even with batteries.

4. The sunshine angle adjustable solar energy electric wheel chair of claim 1, characterized in that the new-type thin solar battery (36) is replaced by a low-power silicon plate solar battery (42), the silicon plate solar battery (42) is integrally mounted on the left and the right horizontally mounted connection pipes (35), screws are aligned with mount holes of the silicon plate battery for fastening the silicon plate battery, and the sunshine angle may be adjusted according to the six directions by using the four lift pipes (34.1), to maximize the charging current of the solar energy battery; the connection of the power supply line is the same as that the power supply line leads to the charging controller (38) through the connection device (37), and is connected to the power connection of the battery box (9) through the charging plug, the difference is that the silicon plate battery cannot be folded and is mounted in a manner of rigid connection instead of elastic connection.

5. The sunshine angle adjustable solar energy electric wheel chair of claim 1, characterized in that: a switching case (18.1) is installed on the right arm-rest pipe (6), two switches (18) for positive or inversion running of the motors and the power display are installed on the switching case (18.1).

6. The sunshine angle adjustable solar energy electric wheel chair of claim 1, characterized in that a hand control direction device is installed on the left elbow (10); the hand control direction device includes a fixing plate (11), a hollow bearing (13), a vertical hand control rod (16), and a hand control direction handle (17); the vertical hand control rod (16) inserting through the hollow bearing (13), its upper end is connected to the hand control direction handle (17), and its lower end is connected to the front steering wheel (4); the connection between the vertical hand control rod (16) and the front steering wheel (4) is: an female screw thread on a tail end of the vertical hand control rod (16) matches a male screw rod on an upper end of a main shaft of the front steering wheel (4), the male screw rod is screwed into a top end of the female screw thread, and is screwed into a positioning screw through a hole.

7. The sunshine angle adjustable solar energy electric wheel chair of claim 1, characterized in that an intellectual control rod (40) is installed on the right elbow (12), to replace the switches (18) of the left and the right motors and the switch box (18.1), and interact with the hand control direction handle (17); at the same time the intellectual control rod (40) also interact with the speed adjusting turning handle (14) and the brake handle (15) integrated in a two-in-one manner.

8. The sunshine angle adjustable solar energy electric wheel chair of claim 2, characterized in that the foldable new-type thin solar battery charging device must match with the foldable electric wheel chair frame: a cross folding device is disposed in the wheel chair frame (1), its base is two front cross pipes (1.41) and two rear cross boards (1.42), the upper end of the two front cross pipes (1.41) and two rear cross boards (1.42) are connected by welding to the left and right horizontally supporting pipes (1.44) of the cushion (7.1), the lower ends of the two front cross pipes (1.41) and two rear cross boards (1.42) are connected by welding to the left and right short pipes (1.45), which may rotate around its inner pipe at a small angle; two cross fold positioning boards (1.43) make the fold and interaction between the two rear cross boards (1.42) and the left and right main vertical pipes (1.3) keep stable by means of four slip-connecting screws (1.48), the cross points of the two front cross pipes (1.41) and the two rear cross boards (1.42) are also connected to each other via the slip-connecting screws (1.48), there is an inner pipe fixing screw (1.47) out of the two ends of the left and right short pipes (1.45) respectively, the screws tightly fix the inner pipes and non-turning outer pipes, there are totally four hook-shaped supporters (1.46) which are welded at the front and rear of the left and right horizontally supporting pipes (1.2) and at the bottom planes tightly close to the supporting pipes (1.2), and used to support the left and right horizontally supporting pipes (1.44) of the cushion (7.1), two long flat vertical plates (1.49) are welded beneath each of the two left hook-shaped supporters and the two right hook-shaped supporters (1.46) respectively for hanging and unhanging the left and right battery boxes (9) conveniently, therefore the electric wheel chair is foldable even with batteries.

9. The sunshine angle adjustable solar energy electric wheel chair of claim 2, characterized in that the new-type thin solar battery (36) is replaced by a low-power silicon plate solar battery (42), the silicon plate solar battery (42) is integrally mounted on the left and the right horizontally mounted connection pipes (35), screws are aligned with mount holes of the silicon plate battery for fastening the silicon plate battery, and the sunshine angle may be adjusted according to the six directions by using the four lift pipes (34.1), to maximize the charging current of the solar energy battery; the connection of the power supply line is the same as that the power supply line leads to the charging controller (38) through the connection device (37), and is connected to the power connection of the battery box (9) through the charging plug, the difference is that the silicon plate battery cannot be folded and is mounted in a manner of rigid connection instead of elastic connection.

10. The sunshine angle adjustable solar energy electric wheel chair of claim 2, characterized in that: a switching case (18.1) is installed on the right arm-rest pipe (6), two switches (18) for positive or inversion running of the motors and the power display are installed on the switching case (18.1).

11. The sunshine angle adjustable solar energy electric wheel chair of claim 2, characterized in that a hand control direction device is installed on the left elbow (10); the hand control direction device includes a fixing plate (11), a hollow bearing (13), a vertical hand control rod (16), and a hand control direction handle (17); the vertical hand control rod (16) inserting through the hollow bearing (13), its upper end is connected to the hand control direction handle (17), and its lower end is connected to the front steering wheel (4); the connection between the vertical hand control rod (16) and the front steering wheel (4) is: an female screw thread on a tail end of the vertical hand control rod (16) matches a male screw rod on an upper end of a main shaft of the front steering wheel (4), the male screw rod is screwed into a top end of the female screw thread, and is screwed into a positioning screw through a hole.

12. The sunshine angle adjustable solar energy electric wheel chair of claim 2, characterized in that an intellectual control rod (40) is installed on the right elbow (12), to replace the switches (18) of the left and the right motors and the switch box (18.1), and interact with the hand control direction handle (17); at the same time the intellectual control rod (40) also interact with the speed adjusting turning handle (14) and the brake handle (15) integrated in a two-in-one manner.
